(19) United States
(12) Patent Application Publication
(10) Pub. No.: US 2007/0240534 A1
(43) Pub. Date: Oct. 18, 2007

(54) Pedal apparatus

(75) Inventor: Masahiro Makino, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/727,434

(22) Filed: Mar. 27, 2007

(30) Foreign Application Priority Data
Apr. 12, 2006 (JP) 2006-109657
Oct. 17, 2006 (JP) 2006-282714

(51) Int. Cl. G05G 1/14

(52) U.S. Cl. 74/513

(57) ABSTRACT

A pedal apparatus including a pedal, a pressuring member for increasing return force when depression of the pedal increases, and a frictional member that generates a frictional resistance. When the pedal is depressed, the frictional resistance acts in the same direction as the return force, and when the pedal is returned, the frictional resistance is applied in an opposite direction as the return force. When the return force decreases, the decrease in the return force in depressing the pedal is compensated by increasing the frictional resistance.

### CROSS REFERENCE TO RELATED APPLICATIONS

The following is based on and claims priority to Japanese Patent Application No. 2006-109657, filed Apr. 12, 2006, and Japanese Patent Application No. 2006-282714, filed Oct. 17, 2006, each of which is incorporated herein by reference.

### FIELD

The following relates generally to a pedal apparatus and, more specifically, to a pedal apparatus in which frictional resistance compensates for decreased return force.

### BACKGROUND

In vehicles such as an automobile, at least one pedal apparatus is typically included. For example, vehicles typically include an accelerator pedal for controlling acceleration of the vehicle (e.g., by controlling an internal-combustion engine of the vehicle). Generally, in the accelerator pedal apparatus, return force to return an accelerator pedal to its initial position is applied by a spring. Moreover, rotational resistance (frictional resistance) is applied to the accelerator pedal by a frictional plate or the like.

When the accelerator pedal is depressed, the rotational resistance is applied in the same direction as the restitution force (spring force). When force (pedal force), by which the accelerator pedal is depressed, is reduced after the accelerator pedal has been depressed, the rotational resistance is applied in an opposite direction of the restitution force. Accordingly, the pedal force, which is equal to the addition of the rotational resistance and the return force, is necessary for depressing the accelerator pedal. On the other hand, the pedal force, which is equal to the subtraction of the return force from the rotational resistance, is necessary for returning the accelerator pedal. As a result, the accelerator pedal displays hysteretic properties as shown in FIG. 11. That is, even if the amount of the depression of the accelerator pedal is the same, the pedal force that is necessary for changing the amount of the depression of the accelerator pedal differs between when the accelerator pedal is depressed and returned. By applying the rotational resistance to the accelerator pedal, when the pedal force is reduced, the rotational resistance is applied even if the pedal force is smaller than the return force that is applied to the accelerator pedal. The amount of the depression of the accelerator pedal does not decrease until the pedal force becomes smaller than the remainder of the subtraction of the rotational resistance from the return force. As such, a desired amount of depression of the accelerator pedal is maintained even if the pedal force fluctuates to a certain extent. This rotational resistance of the accelerator pedal improves operability of the accelerator pedal.

Preferably, the above hysteretic properties increase according to the amount of the depression of the accelerator pedal. An accelerator pedal apparatus in which the hysteretic properties become greater as the amount of the depression of the accelerator pedal increases, is described in, for example, JP6-299874A (corresponding to U.S. Pat. No. 5,529,296).

As shown in FIG. 9, for example, the above conventional accelerator pedal apparatus includes a housing 102, an accelerator pedal 104, a spring rotor 106, and a frictional plate 108. The accelerator pedal 104 rotates around a rotational axis line relative to the housing 102. The spring rotor 106 rotates around the rotational axis line in synchronization with the accelerator pedal 104, and the return force to return the accelerator pedal 104 to its initial position is applied to the spring rotor 106 by a spring 110 or the like. The frictional plate 108 is disposed between the spring rotor 106 and the housing 102. At respective end faces of the accelerator pedal 104 and the spring rotor 106, which are opposed to each other in a direction of the rotational axis line, a plurality of cams 104a, 106a is formed facing a circumferential direction around the rotational axis line. By engaging the cam 104a of the accelerator pedal 104 and the cam 106a of the spring rotor 106, the accelerator pedal 104 and the spring rotor 106 are synchronized, and a portion of the pedal force applied to the accelerator pedal 104 is converted into force that presses the spring rotor 106 against the frictional plate 108 through the cam 104a and the cam 106a. Then, the rotational resistance is applied to the accelerator pedal 104 by friction that is generated between the spring rotor 106 and the frictional plate 108. In addition, the cams 104a, 106a have flat inclined surfaces. As shown in FIGS. 10A, 10B, even if a relative angular position or relative position in the direction of the rotational axis line between the accelerator pedal 104 and the spring rotor 106 varies, a contact angle θ of the cams 104a, 106a (an angle defined between the line of contact of the cams 104a, 106a and a plane perpendicular to the rotational axis) does not change.

Furthermore, in the accelerator pedal apparatus, another example of a frictional force generation mechanism exhibiting the hysteretic properties is described in WO01/19638A1 (corresponding to U.S. Pat. No. 6,745,642). The frictional force generation mechanism in WO01/19638A1 includes a sliding guide path, a first movable frictional member, a second movable frictional member, and a spring. The sliding guide path has a sliding surface to generate frictional force. The first and second movable frictional members are received by the sliding guide path in a reciprocative manner. The spring applies a biasing force that biases the second movable frictional member toward its initial position. The pedal force, which is applied by a pedal arm, is applied to the first movable frictional member. The first and second movable frictional members each include a main body with a generally rectangular shape and two contact arms, which are formed integrally with one end of each main body, and extend along the sliding surfaces of the sliding guide path. Inclined surfaces are formed on the respective main bodies, and the first and second movable frictional members are disposed such that the inclined surface of the first movable frictional member and the inclined surface of the second movable frictional member contact each other. When the spring urges the second movable frictional member and the pedal force is applied to the first movable frictional member by the pedal arm, frictional force is generated to press the first and second movable frictional members against inner wall surfaces of the sliding guide path such that they are separated from each other. In this manner, the frictional force generation mechanism in WO01/19638A1 provides the hysteretic properties to the pedal force necessary for operating the accelerator pedal.

In the accelerator pedal apparatus in JP6-299874A, for example, when the frictional plate and/or the spring rotor wears and becomes thin, the spring rotor moves toward the frictional plate in the direction of the rotational axis because of interaction between the cam of the accelerator pedal and the cam of the spring rotor, and the spring rotor keeps in contact with the frictional plate. Thus, the rotational resistance of the accelerator pedal is provided despite the wear.

However, the spring stretches as a result of rotating of the spring rotor, and the return force applied to the spring rotor by the spring decreases as the amount of the depression of the accelerator pedal approaches zero (0). Furthermore, since the contact angle between the cam of the accelerator pedal and the cam of the spring rotor remains constant, the force that presses the spring rotor against the frictional plate and the rotational resistance caused by this force are the same, if the same pedal force is applied to the accelerator pedal. Accordingly, as shown in FIG. 11, the amount of depression (rotation angle) of the accelerator pedal and the pedal force that is necessary for the amount of the depression vary (as indicated by a solid line in FIG. 11). After the frictional plate wears, the return force applied to the spring rotor decreases, and consequently, the amount of the depression of the accelerator pedal and the pedal force that is necessary for the amount of the depression vary (as indicated by a dashed line in FIG. 11, which is moved downward from the initial state curve). As a result, the pedal force that is necessary for the same amount of the depression of the accelerator pedal is different depending on wear of the frictional plate. Thus, when the accelerator pedal is depressed, a decrease in the pedal force necessary for operating the accelerator pedal can degrade the operational feeling of the pedal.

Likewise, in the frictional force generation mechanism in WO01/19638A1, when the sliding surface of the sliding guide path or the movable frictional member wears, a similar problem occurs.

### SUMMARY

A pedal apparatus is disclosed that includes a pedal for depression by an operator from an initial position. Additionally, the pedal apparatus includes a pressuring member for increasing return force when an amount of depression of the pedal increases. The return force returns the pedal to the initial position. The pedal apparatus also includes a frictional member that generates a frictional resistance. When the pedal is depressed, the frictional resistance is applied to the pedal in the same direction as the return force. Furthermore, when the pedal is returned towards the initial position, the frictional resistance is applied to the pedal in an opposite direction of the return force. Moreover, when the return force, which is applied to the pedal according to a predetermined amount of the depression of the pedal, decreases, the decrease in the return force in depressing the pedal is compensated by increasing the frictional resistance.

### BRIEF DESCRIPTION OF THE DRAWINGS

The disclosure, together with additional objectives, features and advantages thereof, will be best understood from the following description, the appended claims and the accompanying drawings in which:

FIG. 1 is an exploded view of an accelerator pedal apparatus according to a first embodiment;

FIG. 2 is a schematic view showing a principle of operation of an accelerator pedal apparatus;

FIG. 3A is a schematic view showing an interaction between cams of the accelerator pedal apparatus;

FIG. 3B is a schematic view showing the interaction between the cams of the accelerator pedal apparatus;

FIG. 4 is a graph showing a relationship between a rotation angle of an accelerator pedal and pedal force that is necessary when the accelerator pedal apparatus is used;

FIG. 5 is an illustrative diagram showing a procedure for setting a curvature of a curved engaging surface of a cam of the accelerator pedal apparatus;

FIG. 6 is a cross-sectional view of an accelerator pedal apparatus according to a second embodiment;

FIG. 7 is a partial cross-sectional side view of an accelerator pedal apparatus according to a third embodiment;

FIG. 8 is a cross-sectional view showing details of a frictional force generation mechanism of the accelerator pedal apparatus shown in FIG. 7;

FIG. 9 is a schematic view showing an accelerator pedal apparatus of the prior art;

FIG. 10A is a schematic view showing an interaction between cams of the accelerator pedal apparatus of the prior art;

FIG. 10B is a schematic view showing the interaction between the cams of the accelerator pedal apparatus of the prior art; and

FIG. 11 is a graph showing a relationship between a rotation angle of an accelerator pedal and pedal force that is necessary when the accelerator pedal apparatus of the prior art is used.

### DETAILED DESCRIPTION

Embodiments of the present invention will be described with reference to the drawings.

A pedal apparatus (e.g., an accelerator pedal apparatus) is disclosed below that increases return force for returning an accelerator pedal to its initial position as an amount of depression of the accelerator pedal increases. Also, in the accelerator pedal apparatus, a frictional resistance operates in the same direction as the return force when the accelerator pedal is depressed, whereas the frictional resistance operates in an opposite direction of the return force when the accelerator pedal is returned. Furthermore, when the return force applied to the accelerator pedal according to a predetermined amount of the depression of the accelerator pedal decreases, a decrease in the return force in depressing the accelerator pedal is compensated by increasing the frictional resistance.

In order to realize the above functions, an accelerator pedal apparatus in the following embodiments generally includes an accelerator pedal, a pedal force transmission member, a pressuring member, a frictional member, and a force conversion mechanism. An operator applies pedal force to the accelerator pedal. The pedal force applied to the accelerator pedal is transmitted to the pedal force transmission member, which is synchronized with the accelerator pedal. The pressuring member engages with the pedal force transmission member, and the return force for returning the accelerator pedal to its initial position via the pedal force transmission member is applied to the pressuring member by a spring or the like. The frictional member contacts the pressuring member, and the frictional resistance is generated between the pressuring member and the frictional member. The force conversion mechanism includes respective convexly sloped engaging surfaces disposed at opposing surfaces of the pedal force transmission member and the pressuring member, and the convexly sloped engaging surface of the pedal force transmission member engages with the corresponding engaging surface of the pressuring member. A curvature of the convexly sloped engaging surface of the force conversion mechanism is set, such that an angle defined between a plane tangential to an engaging part of the pedal force transmission member and the pressuring member and a plane perpendicular to a direction of force that presses the pressuring member against the frictional member, decreases as the pedal force transmission member and the pressuring member move away from each other in the direction of the force that presses the pressuring member against the frictional member.

In the accelerator pedal apparatus having such a structure, the pedal force applied to the pressuring member through the pedal force transmission member by the accelerator pedal is converted into force that resists the return force applied to the pressuring member and force that presses the pressuring member against the frictional member via the engaging part between the convexly sloped engaging surface of the pedal force transmission member and the convexly sloped engaging surface of the pressuring member. On the other hand, when spring force of the spring decreases, for example, and the return force applied to the accelerator pedal according to a predetermined amount of the depression of the accelerator pedal decreases, by increasing the force that presses the pressuring member against the frictional member, the frictional resistance between the pressuring member and the frictional member can be increased. Accordingly, the decrease in the return force in depressing the accelerator pedal can be compensated.

### First Embodiment

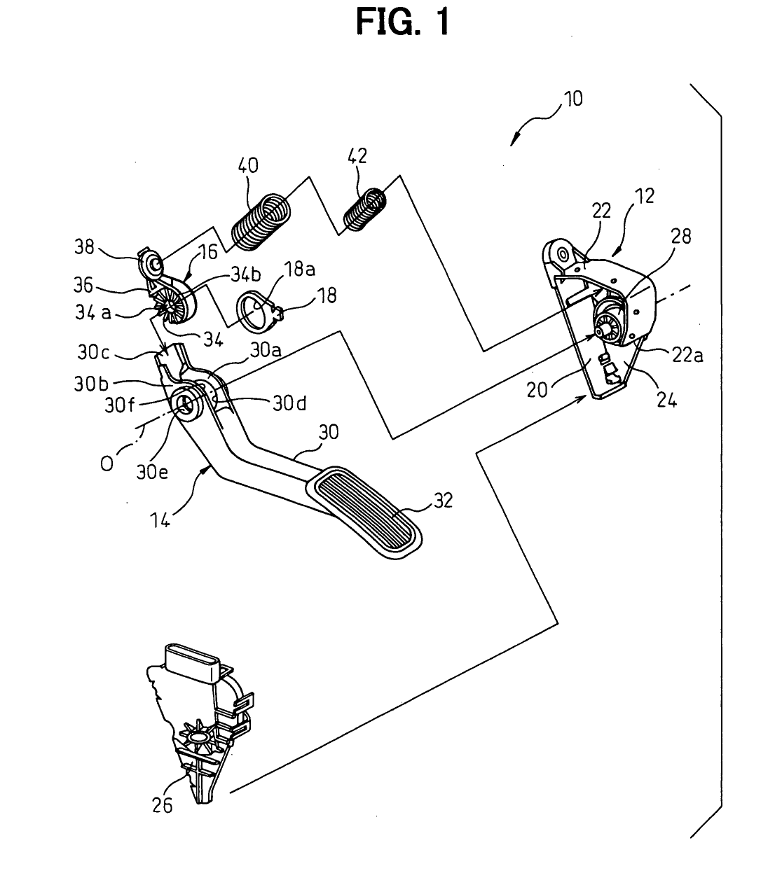

An overall structure of an accelerator pedal apparatus 10 of a first embodiment will be described with reference to FIG. 1. The accelerator pedal apparatus 10 is installed in a vehicle such as an automobile, and controls a traveling state of the vehicle according to an amount of depression of an accelerator pedal. The accelerator pedal apparatus 10 of the first embodiment is employed in a drive-by-wire system. That is, in the accelerator pedal apparatus 10, a vehicle throttle apparatus and the like (not shown) are indirectly coupled to the accelerator pedal 14. A rotation angle of the accelerator pedal 14 is detected by an angle sensor (not shown), and the throttle apparatus is controlled based on the detected rotation angle of the accelerator pedal 14.

The accelerator pedal apparatus 10 includes a housing 12, the accelerator pedal 14, a spring rotor 16, and a friction plate 18. The accelerator pedal 14 is supported by the housing 12 such that it rotates around a rotational axis line O. The spring rotor 16 rotates in synchronization with the accelerator pedal 14 around the same axis line as the rotational axis line O of the accelerator pedal 14. The friction plate 18 is placed between the spring rotor 16 and the housing 12.

The housing 12 includes a bottom plate 20, a top plate 22, and a first and second side plate 24, 26. The bottom plate 20 is fixed to a vehicle body (not shown) through a bolt or the like. The top plate 22 opposes the bottom plate 20, and the top plate 22 is generally V-shaped with a space between the top plate 22 and the bottom plate 20. The side plates 24, 26 are opposed to each other and are perpendicular to the bottom plate 20 and top plate 22. The top plate 22 has an opening 22a, through which the accelerator pedal 14 extends. The side plate 24 has a pivot 28 that extends from its inner surface toward the interior of the housing 12 in a direction of the rotational axis line O.

The accelerator pedal 14 has an arm part 30, which extends in a generally V-shaped manner. The arm part 30 serves as a pedal force transmission member. The arm part 30 includes a pair of side wall parts 30a, 30b and a connecting part 30c. The pair of side wall parts 30a, 30b extends parallel to each other in a longitudinal direction of the arm part 30. The connecting part 30c connects the side wall part 30a and the side wall part 30b. The arm part 30 has an operation part 32, which is depressed by an operator with his/her foot or the like, at one end of the arm part 30. The other end of the arm part 30 is received in the housing 12. This end of the arm part 30 has through holes 30d, 30e, which pass through the pair of side wall parts 30a, 30b respectively. The pivot 28 of the side plate 24 of the housing 12 passes through the through holes 30d, 30e such that the accelerator pedal 14 is rotatably supported by the housing 12 about the rotational axis line O.

The spring rotor 16 serves as a pressuring member. The spring rotor 16 includes a disk-like rotating part 34, a plate-like part 36, and a spring washer part 38. The plate-like part 36 extends from an outer circumferential part of the rotating part 34 in a tangential direction of the rotating part 34. The spring washer part 38 is formed at an end of the plate-like part 36. The spring rotor 16 is placed between the pair of side wall parts 30a, 30b at an end part of the accelerator pedal 14 on a side of the through holes 30d, 30e. The rotating part 34 of the spring rotor 16 has a through hole 34a, through which the pivot 28 passes, and accordingly, the spring rotor 16 is rotatably supported by the housing 12 about the rotational axis line O of the accelerator pedal 14. On one end face of the rotating part 34 in the direction of the rotational axis line O, a plurality of cams 34b is formed at regular intervals around the through hole 34a. The plurality of cams 34b is arranged opposed to a plurality of cams 30f having corresponding shapes and constantly engages with the plurality of cams 30f. The plurality of cams 30f is formed around the through hole 30e on an inner surface of the side wall part 30b of the rotating part 34 on a side of the plurality of cams 34b. The plurality of cams 34b of the spring rotor 16 and the plurality of cams 30f of the accelerator pedal 14 have convex shapes in cross section along the above cylindrical surface. That is, the plurality of cams 34b serves as a convex slope engaging surface of the pressuring member, and the plurality of cams 30f serves as a convex slope engaging surface of the pedal force transmission member.

A first spring 40 with a relatively large diameter and a second spring 42 with a smaller diameter are inserted between the spring washer part 38 of the spring rotor 16 and an inner surface of the top plate 22 of the housing 12 with the second spring 42 inserted into the first spring 40. When the accelerator pedal 14 is depressed, the first spring 40 and the second spring 42 urge the spring rotor 16 in an opposite rotation direction from a rotation direction of the accelerator pedal 14 and spring rotor 16. Hence, when force that is applied to the accelerator pedal 14 is released, the first spring 40 and the second spring 42 return the spring rotor 16 to its initial position, thereby returning the accelerator pedal 14 to its initial position through an interaction between the plurality of cams 34b of the spring rotor 16 and the plurality of cams 30f of the accelerator pedal 14. Because the first spring 40 and the second spring 42 are each included, the return force is applied to the spring rotor 16 even if one of the two springs is damaged, and it is ensured that the accelerator pedal 14 returns to its initial position when pedal force is released.

The friction plate 18 serves as a frictional member. The friction plate 18 is provided between an end face of the rotating part 34 of the spring rotor 16 (on a side opposite of the plurality of cams 34b) in the direction of the rotational axis line O and the side wall part 30a of the accelerator pedal 14, which is opposed to the end face of the rotating part 34. The friction plate 18 is fixed, such that it does not rotate relative to the pivot 28 of the housing 12. A frictional resistance is generated between the friction plate 18 and the side wall part 30a of the accelerator pedal 14 as well as between the friction plate 18 and the end face of the spring rotor 16 in the direction of the rotational axis line when the accelerator pedal 14 and the spring rotor 16 rotate in synchronization. In the embodiment shown, the friction plate 18 includes a through hole 18a, and the pivot 28 of the housing 12 extends through the through hole 18a. Also, in the embodiment shown, the friction plate 18 is fixed (i.e., it does not rotate relative to the pivot 28 of the housing 12) due to coupling of a catching part formed on the friction plate 18 and a corresponding catching part formed on the top plate 22 of the housing 12.

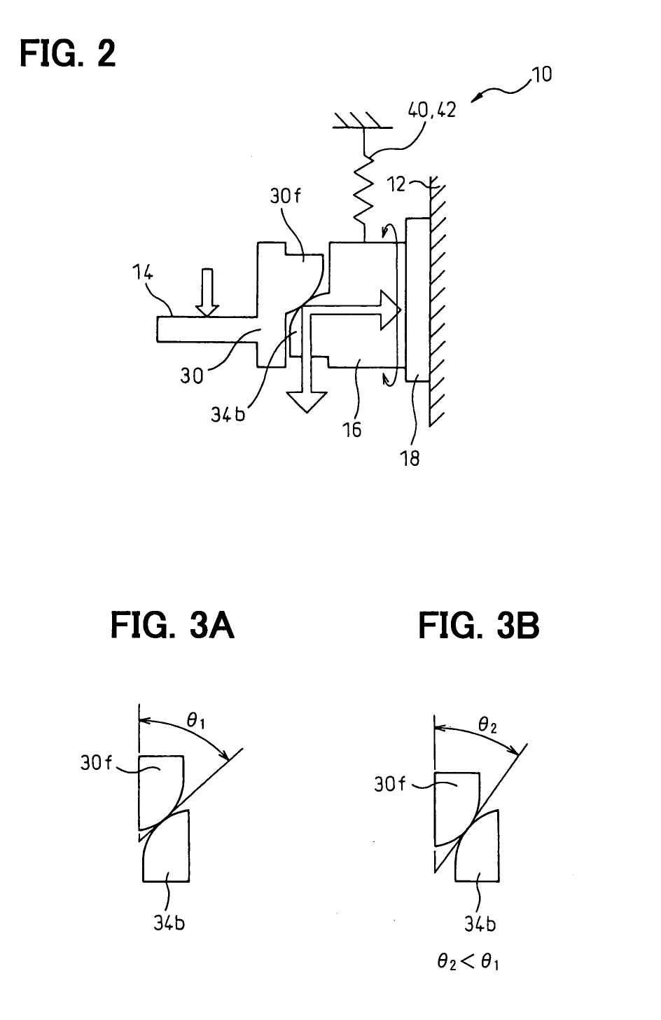

Next, an operation of the accelerator pedal apparatus of FIG. 1 will be described with reference to FIG. 2. FIG. 2 is a schematic view illustrating operating principles of the accelerator pedal apparatus 10 of the present disclosure.

When the pedal force is applied to the operation part 32 of the accelerator pedal 14, the accelerator pedal 14 rotates around the rotational axis line O. Rotating force that operates upon the accelerator pedal 14 is transmitted to the spring rotor 16 through engagement between the cam 34b of the spring rotor 16 and the cam 30f of the accelerator pedal 14. More specifically, as indicated by arrows in FIG. 2, as a result of the interaction between the cam 30f of the accelerator pedal 14 and the cam 34b of the spring rotor 16, the pedal force applied to the accelerator pedal 14 is decomposed into a force (rotating force Fr) that rotates the spring rotor 16 around the rotational axis line O and a force (pressing force Fp) that presses the spring rotor 16 in the direction of the rotational axis line O against the friction plate 18. The rotating force Fr and pressing force Fp are transmitted to the spring rotor 16. That is, the cam 30f of the accelerator pedal 14 and the cam 34b of the spring rotor 16 constitute a force conversion mechanism.

The rotating force Fr rotates the spring rotor 16 in synchronization with the accelerator pedal 14 until the rotating force Fr equals the return force applied to the spring rotor 16. The pressing force Fp generates the frictional resistance between the end face of the rotating spring rotor 16 in the direction of the rotational axis line and the friction plate 18 as well as between the friction plate 18 and the housing 12. The frictional resistance is generated in an opposite direction from the rotation direction of the accelerator pedal 14, that is, from the rotation direction of spring rotor 16. Therefore, when the accelerator pedal 14 is depressed, the frictional resistance is applied in the same direction as the return force applied to the spring rotor 16, and the pedal force that corresponds to the resultant of the return force and frictional resistance is necessary for an operation of the accelerator pedal 14. On the other hand, when the accelerator pedal 14 is returned to its initial position, the frictional resistance is applied in an opposite direction from the return force applied to the spring rotor 16. Accordingly, the pedal force that corresponds to the remainder after subtraction of the frictional resistance from the return force is necessary for the operation of the accelerator pedal 14. Consequently, even if the amount of the depression (rotation angle) of the accelerator pedal 14 is the same, the pedal force that is necessary for the operation differs between when the accelerator pedal 14 is depressed and returned, so that hysteretic properties can be obtained. The hysteretic properties facilitate the operation of the accelerator pedal 14.

In the accelerator pedal apparatus 10 shown in FIG. 1, as the friction plate 18 or the spring rotor 16 wears, the cam 34b of the spring rotor 16 moves along an engaging surface of the cam 30f of the accelerator pedal 14 with the spring rotor 16 rotating around the rotational axis line O relative to the accelerator pedal 14 by means of the first spring 40 and the second spring 42. As such, the spring rotor 16 moves away from the accelerator pedal 14 along the rotational axis line O toward the friction plate 18 (FIGS. 3A, 3B). Accordingly, even if the friction plate 18 or the spring rotor 16 decreases in thickness due to wearing, the spring rotor 16 and the friction plate 18 remain in contact with each other. Thus, it is ensured that the frictional resistance is generated between the spring rotor 16 and the friction plate 18 when the spring rotor 16 rotates. On the other hand, the spring rotor 16 absorbs a decrease in thickness of the friction plate 18 or the spring rotor 16 by rotating in a direction, in which the first spring 40 and the second spring 42 stretch. Consequently, a compression amount of the first spring 40 and the second spring 42 at the initial position of the accelerator pedal 14 decreases compared to before the wearing of the friction plate 18 or the spring rotor 16. Thus, the return force applied to the spring rotor 16 by the first and second springs 40, 42 decreases compared to before the wearing of the friction plate 18 or the spring rotor 16.

As shown in FIG. 9, in a conventional accelerator pedal apparatus 100, the cams 104a, 106a each include evenly inclined (i.e., flat) surfaces that engage each other. Hence, as can be seen from 10A, 10B, even if a spring rotor 106 rotates relative to an accelerator pedal 104 to account for an amount of wear of a friction plate 108 so that the spring rotor 106 moves away from the accelerator pedal 104 in a direction of a rotational axis line O as described above, a contact angle θ between the cam 104a of the accelerator pedal 104 and the cam 106a of the spring rotor 106 remains constant. Therefore, in the conventional accelerator pedal apparatus 100, a ratio, in which the pedal force applied to the accelerator pedal 104 is converted into the rotating force Fr and the pressing force Fp, is constant even if the friction plate 108 wears.

When the friction plate 108 or the spring rotor 106 wears, the spring rotor 106 rotates around the rotational axis line O and a spring 110 stretches, so that the return force applied to the spring rotor 106 decreases. As a result, a relationship between the rotation angle of the accelerator pedal 104 and the return force applied to the spring rotor 106 changes. A decrease in the return force is shown with a dashed-dotted line (before decreasing) and a dashed-two dotted line (after decreasing) in FIG. 11. Furthermore, when the return force applied to the spring rotor 106 decreases, the pedal force that is necessary for operating the accelerator pedal 104 at a desired rotation angle decreases. If the ratio, in which the pedal force applied to the accelerator pedal 104 is converted into the rotating force Fr and the pressing force Fp, is constant, the pressing force Fp decreases as the pedal force decreases, so that the frictional resistance decreases. Accordingly, a relationship between the rotation angle of the accelerator pedal 104 and the pedal force changes from that indicated by a continuous line (before the wearing of the friction plate 108) to that indicated by a dashed line (after the wearing of the friction plate 108), thereby changing the operator's feeling of operating the accelerator pedal 104.

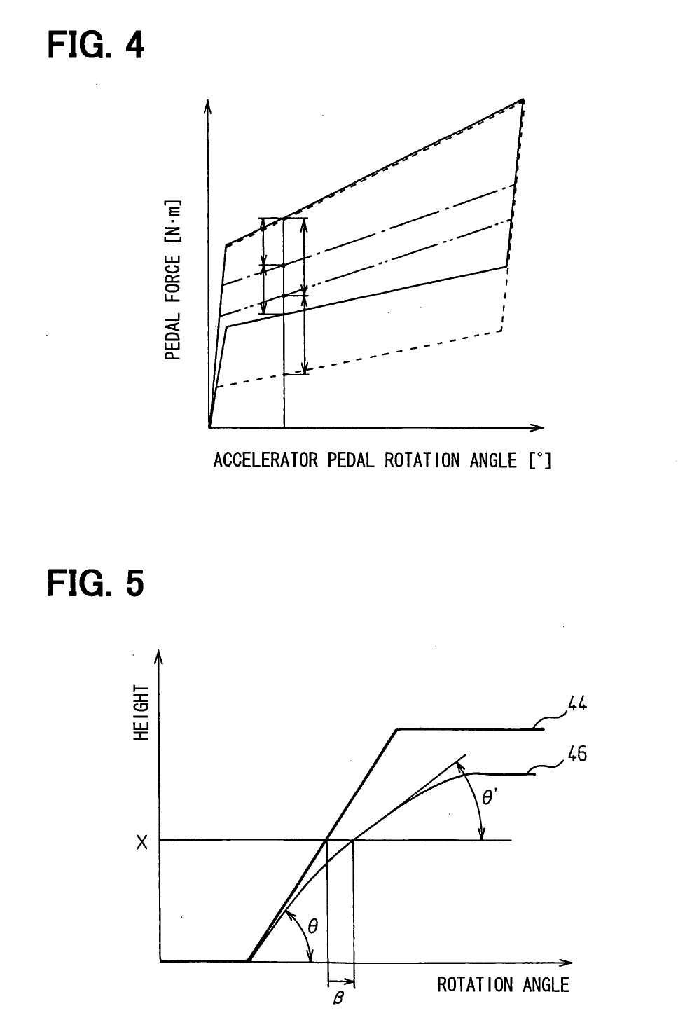

The engaging surfaces (cam surfaces) of the cam 30f of the accelerator pedal 14 and the cam 34b of the spring rotor 16 in the accelerator pedal apparatus 10 have convexly curved shapes in cross section along a cylindrical surface that is set around the rotational axis line O passing through the cams 30f, 34b. As can be seen from 3A, 3B, when a gap between the accelerator pedal 14 and the spring rotor 16 opens up in the direction of a rotational axis line O due to the wearing of the friction plate 18 or the spring rotor 16, the contact angle between the cam 30f of the accelerator pedal 14 and the cam 34b of the spring rotor 16 decreases from θ1 to θ2. Hence, when the friction plate 18 or the spring rotor 16 wears, a ratio, in which the pedal force applied to the accelerator pedal 14 is converted into the pressing force Fp, increases, thereby increasing the frictional resistance between the spring rotor 16 and the friction plate 18. When the accelerator pedal 14 is depressed, since the return force applied to the spring rotor 16 and the frictional resistance are applied to the accelerator pedal 14 in the same direction, the pedal force necessary for operating the accelerator pedal 14 at a desired rotation angle is determined by adding the return force and the frictional resistance. Thus, in the accelerator pedal apparatus 10, when the accelerator pedal 14 is depressed, a decrease in the return force is compensated with an increase in the frictional resistance. Thus, there is less of an effect that a decrease in the return force has upon the operator's feeling of operating the accelerator pedal 14. As shown in FIG. 4, when the accelerator pedal 14 is depressed, by setting curvatures of the engaging surfaces of the cams 30f, 34b such that the pedal force necessary for operating the accelerator pedal 14 at a certain rotation angle is the same before and after the return force decreases, the pedal force necessary for depressing the accelerator pedal 14 does not vary before and after the return force decreases. Therefore, the effect that the decrease in the return force has upon a feeling of the operation is reduced.

When the accelerator pedal 14 is returned, since the return force and the frictional resistance are applied to the spring rotor 16 in an opposite direction from each other, the pedal force necessary for operating the accelerator pedal 14 decreases compared to that before the wear, as can be seen from FIG. 4. However, an effect that the pedal force necessary for returning the accelerator pedal 14 has upon the feeling of the operation is small compared to the pedal force necessary for depressing the accelerator pedal 14, thereby significantly improving the operator's feeling of the operation in an overall operation of the accelerator pedal 14.

The engaging surfaces (cam surfaces) of the cam 30f of the accelerator pedal 14 and the cam 34b of the spring rotor 16, which are shown as a curve on a cross-sectional surface along a cylindrical surface that is set around the rotational axis line O to pass through the cams 30f, 34b. With reference to FIG. 5, an example of a method for setting a curvature of the curve will be described.

As shown in FIG. 4, when the accelerator pedal 14 is depressed, curvatures of the engaging surfaces of the cam 30f and the cam 34b are set, such that the pedal force necessary for operating the accelerator pedal 14 at each rotation angle is the same before and after the return force decreases. In addition, in FIG. 5, a curve 44 indicates a flat engaging surface of the cam of the conventional accelerator pedal apparatus 100, and a curve 46 indicates the convexly curved surface of the cam of the accelerator pedal apparatus 10.

The following description will be provided, given the pedal force F, which is applied to the operation part 32 of the accelerator pedal 14, the return force Fsp, which is applied to the spring rotor 16 by the first spring 40 and the second spring 42, rotary torque T, which is applied to the accelerator pedal 14 by the pedal force F, rotary torque Tsp, which is applied to the spring rotor 16 by the return force Fsp, a distance R1 between the rotational axis line O of the accelerator pedal 14 and the operation part 32, a distance R2 between the rotational axis line O of the spring rotor 16 and a point of application of the return force, the contact angle θ between the cam 30f of the accelerator pedal 14 and the cam 34b of the spring rotor 16, and a friction coefficient μ between the spring rotor 16 and the friction plate 18.

A relationship between the rotary torque T applied to the accelerator pedal 14 by the pedal force F and the rotary torque Tsp applied to the spring rotor 16 by the return force Fsp is expressed as follows:

T=Tsp±T·μ/tan θ=Tsp(1±μ/tan θ)

By substituting T=F×R1, Tsp=Fsp×R2 for the above equation, the following equation is obtained:

F=Fsp×R2/(1±μ/tan θ)/R1 (1)

As shown in FIG. 5, if the friction plate 18 or the spring rotor 16 wears and decreases in thickness by X, the spring rotor 16 moves along the rotational axis line O to account for the decrease in thickness of the friction plate 18 or the spring rotor 16 as described above, and meanwhile a contact point between the cam 30f and the cam 34b moves, so that the contact angle turns from θ to θ′. Accordingly, the spring rotor 16 rotates by an angle β by urging force of the first spring 40 and the second spring 42. Set length of the first spring 40 and the second spring 42 stretches by (R2) sin β, and the return force Fsp′ is applied to the spring rotor 16 by the first spring 40 and the second spring 42.

When the accelerator pedal 14 is depressed, if the pedal force does not differ between before and after the wearing, the following equation is obtained using the equation (1):

Fsp×R2/(1+μ/tan θ)/R1=Fsp′×R2/(1+μ/tan θ′)/R1

Since Fsp, Fsp′, μ, R1, and R2 are known, by solving the above equation for θ′, curvatures of the cam 30f and the cam 34b as shown in the curve 46 in FIG. 5 are obtained.

### Second Embodiment

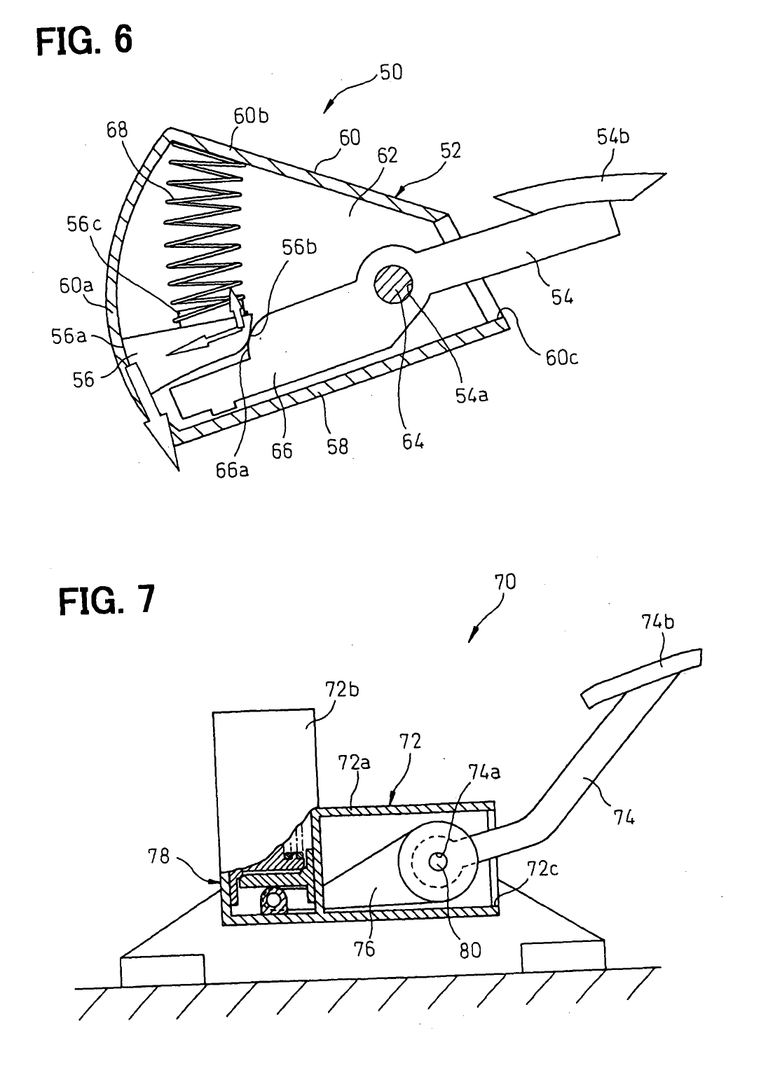

With reference to FIG. 6, an overall structure of an accelerator pedal apparatus 50 of a second embodiment will be described.

The accelerator pedal apparatus 50 is employed in a drive-by-wire system in one embodiment. The accelerator pedal apparatus 50 includes a housing 52, an accelerator pedal 54, and a spring slider 56. The accelerator pedal 54 is supported by the housing 52 such that the accelerator pedal 54 rotates around a rotational axis line O. The spring slider 56 rotates around the same axis line as the rotational axis line O in synchronization with the accelerator pedal 54.

The housing 52 includes a bottom plate 58, a top plate 60, and a side plate 62. (Only one of the side plates 62 is shown in FIG. 6.) The bottom plate 58 is fixed to a vehicle body (not shown) via a bolt or the like. The top plate 60 is opposed to the bottom plate 58, and a space is formed between the top plate 60 and the bottom plate 58. The side plates 62 are placed perpendicular to the bottom plate 58 and the top plate 60, and are opposed to each other. The top plate 60 includes a contact wall part 60a and a surrounding wall part 60b, which is the other component. The contact wall part 60a extends in a circular arc manner with the rotational axis line O being its center from a part coupled to the bottom plate 58 on a cross-sectional surface that is perpendicular to the rotational axis line O of the accelerator pedal 54. The contact wall part 60a serves as a friction member, and the spring slider 56 contacts an inner surface of the contact wall part 60a. An opening 60c, through which the accelerator pedal 54 extends, is formed at the surrounding wall part 60b. The side plate 62 has an axis part 64, which extends from an inner surface of the side plate 62 toward the interior of the housing 52 in the direction of the rotational axis line O.

A through hole 54a is formed at one end of the accelerator pedal 54. When the axis part 64 extending from the side plate 62 of the housing 52 passes through the through hole 54a, the accelerator pedal 54 is supported by the housing 52 rotatably around the rotational axis line O. An operation part 54b is provided at the other end of the accelerator pedal 54, and the operator depresses the operation part 54b with a foot or the like to apply the pedal force to the accelerator pedal 54. A lever 66, which extends from the rotational axis line O in an opposite direction of the accelerator pedal 54 and is received in the housing 52, is integrally coupled to the accelerator pedal 54 at the end of the accelerator pedal 54 on a side of the through hole 54a (the rotational axis line O). The lever 66 serves as the pedal force transmission member. When the pedal force is applied to the operation part 54b of the accelerator pedal 54, the lever 66 rotates around the rotational axis line O in synchronization with the accelerator pedal 54, and transmits the pedal force to the spring slider 56. A convexly curved sloped engaging surface 66a on the cross-sectional surface that is perpendicular to the rotational axis line O is formed on a surface of the lever 66 that faces the spring slider 56 in a rotation direction of the lever 66.

The spring slider 56 serves as the pressuring member. The spring slider 56 includes a contact surface 56a, a convexly sloped engaging surface 56b, and a spring washer part 56c. The contact surface 56a is formed in an area that contacts the inner surface of the contact wall part 60a of the housing 52. The convexly sloped engaging surface 56b is formed on a surface that faces the lever 66 in the rotation direction of the lever 66. The spring washer part 56c is formed on a surface of the spring slider 56 on the other side of the lever 66.

The contact surface 56a has a circular arc shape that corresponds to that of the inner surface of the contact wall part 60a of the housing 52 on the cross-sectional surface that is perpendicular to the rotational axis line O, such that the spring slider 56 rotates around the rotational axis line O in a sliding manner along the inner surface of the contact wall part 60a of the housing 52. The convexly sloped engaging surface 56b of the spring slider 56 is convexly curved on the cross-sectional surface that is perpendicular to the rotational axis line O similar to the convexly sloped engaging surface 66a of the lever 66. The convexly sloped engaging surface 56b of the spring slider 56 is opposed to the convexly sloped engaging surface 66a of the lever 66 in the rotation direction of the lever 66. Accordingly, the lever 66 and the spring slider 56 engage with each other at the convexly sloped engaging surface 66a of the lever 66 and the convexly sloped engaging surface 56b of the spring slider 56. When the pedal force is applied to the accelerator pedal 54, the pedal force, which is transmitted from the accelerator pedal 54 to the lever 66, is transmitted to the spring slider 56 via the convexly sloped engaging surface 66a of the lever 66 and the convexly sloped engaging surface 56b of the spring slider 56. Then the pedal force rotates the spring slider 56 together with the accelerator pedal 54 and the lever 66 around the rotational axis line O along the inner surface of the contact wall part 60a of the housing 52

A spring 68 is inserted between the spring washer part 56c of the spring slider 56 and an inner surface of the surrounding wall part 60b of the housing 52, which is opposed to the spring washer part 56c. When the accelerator pedal 54 is depressed, the spring 68 urges the spring slider 56 in an opposite direction of the rotation direction of the lever 66 and the spring slider 56. Thus, when the pedal force applied to the accelerator pedal 54 is released, the spring 68 returns the spring slider 56 to its initial position, and rotates the lever 66 that engages with the spring slider 56 to return the accelerator pedal 54 to its initial position. Additionally, although only one spring 68 is provided in the second embodiment shown in FIG. 6, two springs may be provided similar to the first embodiment.

Similar to the accelerator pedal apparatus 10 of the first embodiment, in the accelerator pedal apparatus 50 of the second embodiment, curvatures of curves, which are shown on the cross-sectional surface that is perpendicular to the rotational axis line O by the convexly sloped engaging surface 66a of the lever 66 and the convexly sloped engaging surface 56b of the spring slider 56, is set in the following manner. That is, the curvatures are set, such that the pedal force that is necessary for a constant amount of depression of the accelerator pedal 54 is approximately the same before and after a thickness (i.e., width in a radial direction from the rotational axis line O) of the contact wall part 60a or the spring slider 56 decreases. A method of obtaining the curvatures of the curves shown on the cross-sectional surface that is perpendicular to the rotational axis line O by the convexly sloped engaging surface 66a of the lever 66 and the convexly sloped engaging surface 56b of the spring slider 56 is similar to that of the first embodiment, so a detailed explanation will be omitted here.

Next, an operation of the accelerator pedal apparatus 50 of the embodiment shown in FIG. 6 will be described.

When the pedal force is applied to the operation part 54b of the accelerator pedal 54, the accelerator pedal 54 and the lever 66 rotate around the rotational axis line O. The pedal force applied to the accelerator pedal 54 is transmitted to the spring slider 56 through engagement between the convexly sloped engaging surface 66a of the lever 66 and the convexly sloped engaging surface 56b of the spring slider 56. More specifically, as a result of an interaction between the convexly sloped engaging surface 66a of the lever 66 and the convexly sloped engaging surface 56b of the spring slider 56, the pedal force applied to the accelerator pedal 54 is decomposed into force (rotating force) that rotates the spring slider 56 around the rotational axis line O and force (pressing force) that presses the contact surface 56a of the spring slider 56 against the inner surface of the contact wall part 60a of the housing 52 to be transmitted to the spring slider 56.

The rotating force rotates the spring slider 56 around the rotational axis line O. The pressing force presses the contact surface 56a of the spring slider 56 against the inner surface of the contact wall part 60a of the housing 52 to generate the frictional resistance between the contact surface 56a of the spring slider 56, which rotates around the rotational axis line O, and the inner surface of the contact wall part 60a of the housing 52. The frictional resistance is generated in an opposite direction of a rotation direction of the accelerator pedal 54, that is, a rotation direction of the spring slider 56. Consequently, when the accelerator pedal 54 is depressed, the frictional resistance is applied in the same direction as the return force applied to the spring slider 56, and thus the pedal force, which corresponds to the resultant of the return force and the frictional resistance, is necessary for operating the accelerator pedal 54. On the other hand, when the accelerator pedal 54 is returned, the frictional resistance is applied in the opposite direction of the return force applied to the spring slider 56, so that the pedal force that corresponds to the remainder of subtraction of the frictional resistance from the return force is necessary for operating the accelerator pedal 54. Therefore, even if the amount of the depression (rotation angle) of the accelerator pedal 54 is the same, the pedal force that is necessary for the operation differs between when the accelerator pedal 54 is depressed and returned, so that the hysteretic properties can be obtained. The hysteretic properties facilitate the operation of the accelerator pedal 54.

When the contact wall part 60a of the housing 52 or the spring slider 56 wears, the spring slider 56 moves along the convexly sloped engaging surface 66a of the lever 66 to approach the lever 66 in the rotation direction of the spring slider 56 by the spring 68, and accordingly, the spring slider 56 moves toward the inner surface of the contact wall part 60a of the housing 52 away from the rotational axis line O. As a result, even if the thickness of the contact wall part 60a of the housing 52 or the spring slider 56 decreases due to the wearing, the inner surface of the contact wall part 60a of the housing 52 and the contact surface 56a of the spring slider 56 are constantly kept in contact with each other, thereby ensuring constant generation of the frictional resistance between the inner surface of the contact wall part 60a and the spring slider 56 when the spring slider 56 rotates. In this manner, the spring slider 56 absorbs the decrease in the thickness of the contact wall part 60a or the spring slider 56 by rotating in a direction in which the spring 68 stretches. Thus, the amount of compression of the spring 68 when the accelerator pedal 54 is in its initial position decreases as compared to that before the wearing, and the return force applied to the spring slider 56 by the spring 68 decreases as compared to that before the wearing of the contact wall part 60a or the spring slider 56.

Nevertheless, the convexly sloped engaging surface 66a of the lever 66 and the convexly sloped engaging surface 56b of the spring slider 56 of the accelerator pedal apparatus 50 of the second embodiment have convexly curved shapes on the cross-sectional surface that is perpendicular to the rotational axis line O. When the lever 66 and the spring slider 56 are separated in a direction of application of the pressing force due to the wearing of the contact wall part 60a of the housing 52 or the spring slider 56, an angle, which a tangent plane at an engaging part of the convexly sloped engaging surface 66a of the lever 66 and the convexly sloped engaging surface 56b of the spring slider 56 makes with a plane that is perpendicular to the direction of application of the pressing force, decreases. Accordingly, a ratio, in which the pedal force applied to the accelerator pedal 54 is converted into the pressing force, increases, thereby increasing the frictional resistance between the contact surface 56a of the spring slider 56 and the inner surface of the contact wall part 60a of the housing 52. Therefore, in the accelerator pedal apparatus 50 of the second embodiment, when the accelerator pedal 54 is depressed, the decrease in the return force is compensated with the increase in the frictional resistance, thereby decreasing an effect that the decrease in the return force has upon a feeling of the operation of the accelerator pedal 54. More specifically, by setting curvatures of the convexly sloped engaging surfaces 56b, 66a, such that when the accelerator pedal 54 is depressed, the pedal force that is necessary for operating the accelerator pedal 54 at a predetermined rotation angle is the same before and after the return force decreases, the pedal force that is necessary for depressing the accelerator pedal 54 does not differ between before and after the return force decreases. Hence, the effect that the decrease in the return force has upon the feeling of the operation becomes marginal.

### Third Embodiment

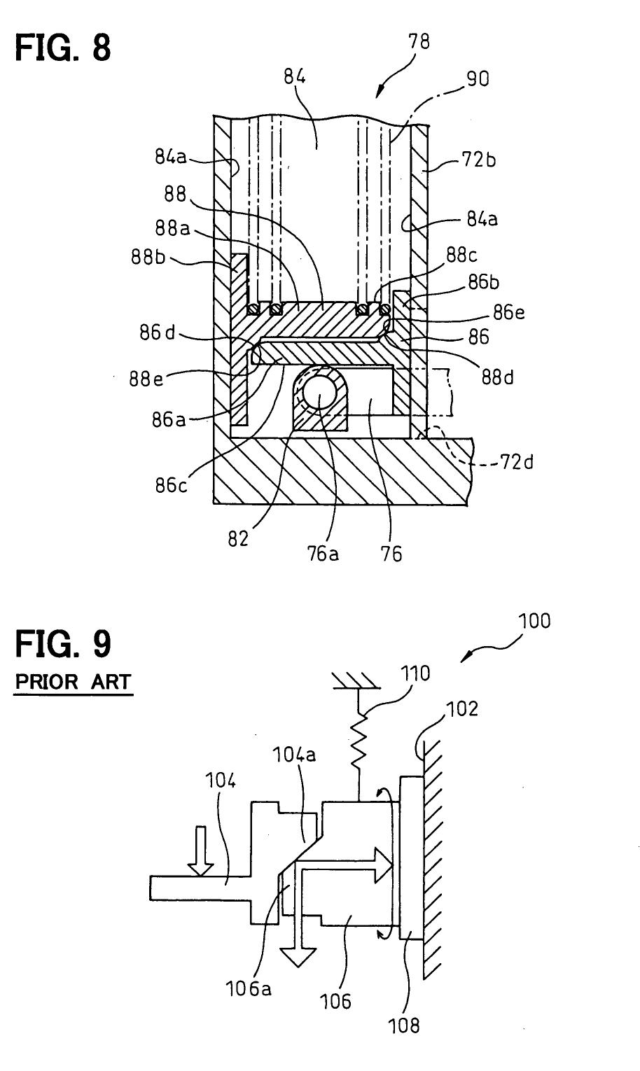

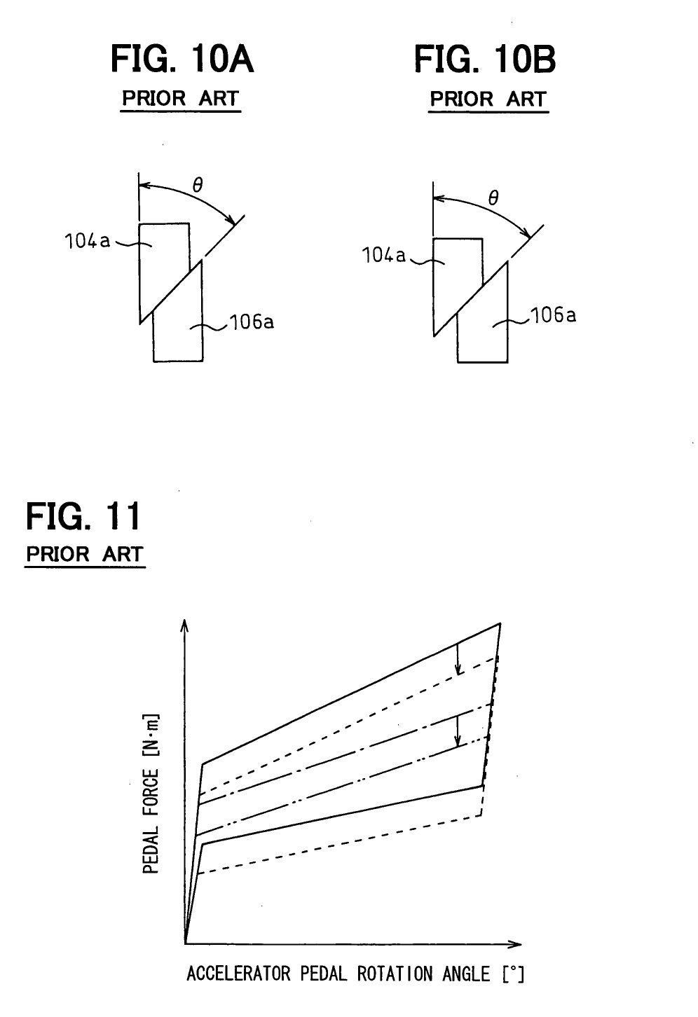

With reference to FIGS. 7, 8, an overall structure of an accelerator pedal apparatus 70 of a third embodiment will be described.

In one embodiment, the accelerator pedal apparatus 70 is employed in a drive-by-wire system. The accelerator pedal apparatus 70 includes a housing 72, an accelerator pedal 74, a lever 76, and a frictional force generation mechanism 78. The accelerator pedal 74 is supported by the housing 72 rotatably around a rotational axis line O. The lever 76 is formed integrally with the accelerator pedal 74, and is supported by the housing 72 rotatably around the rotational axis line O. The frictional force generation mechanism 78 is provided inside the housing 72.

The housing 72 includes a first housing part 72a and a second housing part 72b. The first housing part 72a has a rectangular parallelepiped shape and has a pivot 80 that rotatably supports the accelerator pedal 74. The second housing part 72b has a rectangular parallelepiped shape, and receives the frictional force generation mechanism 78. The first housing part 72a has an opening 72c, through which the accelerator pedal 74 passes. An opening 72d is formed in a joining area of the first housing part 72a and the second housing part 72b, and the lever 76 passes from the first housing part 72a to the second housing part 72b through the opening 72d.

At one end of the accelerator pedal 74, an operation part 74b is provided, and the operator depresses the operation part 74b with a foot or the like to apply the pedal force to the accelerator pedal 74. A through hole 74a is provided at the other end of the accelerator pedal 74. When the pivot 80, which is provided inside the first housing part 72a, passes through the through hole 74a, the accelerator pedal 74 is rotatably supported around the rotational axis line O inside the first housing part 72a.

The lever 76 is on the opposite side of the accelerator pedal 74 with the pivot 80 (rotational axis line O) therebetween, and is formed integrally with the accelerator pedal 74. The lever 76, as well as the accelerator pedal 74, is supported rotatably around the rotational axis line O. The lever 76 extends from the pivot 80 in the first housing part 72a into the second housing part 72b through the opening 72d provided in the joining area of the first housing part 72a and the second housing part 72b. A contact member 82 is rotatably supported around a rotational axis 76a by an end of the lever 76 on a side of the second housing part 72b. The contact member 82 engages with and is detached from a moving member 86 of the frictional force generation mechanism 78, which will be described later. The contact member 82 serves to reliably transmit the pedal force, which is transmitted from the accelerator pedal 74 to the lever 76 when the lever 76 rotates around the rotational axis line O to the moving member 86.

The frictional force generation mechanism 78 generates the frictional force by rotating the accelerator pedal 74, and is formed inside the second housing part 72b. The frictional force generation mechanism 78 includes a sliding guide path 84, the moving member 86 and a spring slider 88, and a spring 90. The sliding guide path 84 extends in a longitudinal direction of the second housing part 72b (i.e., in a vertical direction in FIG. 8). The moving member 86 and spring slider 88 are slidably received in the sliding guide path 84, and are disposed in opposition to each other.

The sliding guide path 84 has a generally rectangular section on a horizontal cross section in FIG. 8. An inner wall surface of the sliding guide path 84 serves as a slide surface 84a. The moving member 86 and spring slider 88 slide along and are guided by the slide surface 84a.

The moving member 86 serves as the pedal force transmission member. The moving member 86 includes a main body 86a and a sliding plate part 86b. The main body 86a is generally flat and plate-like. The sliding plate part 86b is joined to one end (joining end) of the main body 86a in a generally T-shaped manner with the main body 86a, and extends from the one end of the main body 86a along the sliding guide path 84 in both directions. The sliding plate part 86b contacts the slide surface 84a of the sliding guide path 84 and slides along the slide surface 84a. A surface of the main body 86a of the moving member 86, which faces the contact member 82, serves as a contact surface 86c that the contact member 82 is in contact with. When the lever 76 rotates around the rotational axis line O, the contact member 82, which rotates around the rotational axis line O, contacts the contact surface 86c of the moving member 86. Consequently, the pedal force is transmitted from the lever 76 to the moving member 86, and the moving member 86 slides along the sliding guide path 84. A surface of the moving member 86, which faces the spring slider 88 in a sliding direction (i.e., a surface of the moving member 86 on the side opposite the contact surface 86c) engages with the spring slider 88. Sloped engaging surfaces 86d, 86e, which have convexly curved shapes on the cross-sectional surface that is perpendicular to the rotational axis line O, are formed on a free end of the moving member 86 and on a joining end of the moving member 86, respectively.

The spring slider 88 serves as the pressuring member. The spring slider 88 includes a main body 88a, a sliding plate part 88b, and a spring washer part 88c. The main body 88a is generally flat and plate-like. The sliding plate part 88b is joined to one end (joining end) of the main body 88a in a generally T-shaped manner with the main body 88a, and extends from the one end of the main body 88a along the sliding guide path 84 in both directions. The spring washer part 88c is formed at a central part of a surface of the main body 88a on the other side of the moving member 86. The sliding plate part 88b contacts and slides on the slide surface 84a opposite from the slide surface 84a that the sliding plate part 86b of the moving member 86 contacts. A sloped engaging surface 88d, which has a convexly curved shape on the cross-sectional surface that is perpendicular to the rotational axis line O, is formed on a free end side of a surface of the spring slider 88, with the surface facing the moving member 86 in the sliding direction. A sloped engaging surface 88e, which has a convexly curved shape on the cross-sectional surface that is perpendicular to the rotational axis line O, is formed on a joining end side of the above surface of the spring slider 88. The convex sloped engaging surface 88d on the free end side of the spring slider 88 and the convex sloped engaging surface 88e on the joining end side are opposed to the convex sloped engaging surface 86e on the joining end side of the moving member 86 and the convex sloped engaging surface 86d on the free end side in the sliding direction, respectively. The moving member 86 engages with the spring slider 88 when the convex sloped engaging surfaces 86d, 86e of the moving member 86 engage with the convex sloped engaging surfaces 88e, 88d of the spring slider 88, respectively. Accordingly, when the pedal force is applied to the accelerator pedal 74, the pedal force is transmitted from the accelerator pedal 74 to the moving member 86 through the lever 76 and the contact member 82, and is transmitted to the spring slider 88 via the convex sloped engaging surfaces 86d, 86e of the moving member 86 and the convex sloped engaging surfaces 88e, 88d of the spring slider 88, thereby moving the spring slider 88 along the slide surface 84a of the sliding guide path 84.

The spring 90 is provided between the spring washer part 88c of the spring slider 88 and an end face of the second housing part 72b, which is located at an end of the sliding guide path 84. When the accelerator pedal 74 is depressed, the spring 90 urges the spring slider 88 in an opposite direction of the direction in which the moving member 86 and the spring slider 88 slide. When the pedal force applied to the accelerator pedal 74 is released, the spring 90 returns the spring slider 88 to its initial position. Then, the moving member 86 that engages with the spring slider 88 is rotated to return the accelerator pedal 74 to its initial position via the contact member 82 and the lever 76. In addition, although two springs 90 are provided in the third embodiment shown in FIG. 8, only one spring may be provided similar to the second embodiment.

In the accelerator pedal apparatus 70 of the third embodiment as well, curvatures of curves shown on the cross-sectional surface that is perpendicular to the rotational axis line O by the convex sloped engaging surfaces 86d, 86e of the moving member 86 and the convex sloped engaging surfaces 88e, 88d of the spring slider 88 are set, such that the pedal force that is necessary for a constant amount of the depression of the accelerator pedal 74 is approximately the same before and after a thickness (width in a direction perpendicular to the slide surface 84a) of a wall (slide surface 84a) of the sliding guide path 84 or the spring slider 88 decreases. A method of obtaining the curvatures of the curves shown on the cross-sectional surface that is perpendicular to the rotational axis line O by the convex sloped engaging surfaces 86d, 86e and the convex sloped engaging surfaces 88e, 88d is similar to that of the first embodiment, so a detailed explanation will be omitted here.

Next, an operation of the accelerator pedal apparatus 70 of the embodiment shown in FIGS. 7, 8 will be described.

When the pedal force is applied to the operation part 74b of the accelerator pedal 74, the lever 76 and the contact member 82 rotate around the rotational axis line O, and the pedal force applied to the accelerator pedal 74 is transmitted to the spring slider 88 through engagement between the convex sloped engaging surfaces 86d, 86e of the moving member 86 and the convex sloped engaging surfaces 88e, 88d of the spring slider 88. More specifically, due to an interaction between the convex sloped engaging surfaces 86d, 86e and the convex sloped engaging surfaces 88e, 88d, the pedal force applied to the accelerator pedal 74 is decomposed into force (sliding force) that slides the spring slider 88 along the sliding guide path 84 and force (pressing force) that presses the spring slider 88 against the slide surface 84a of the sliding guide path 84 to be transmitted to the spring slider 88.

The sliding force slides the spring slider 88 along the sliding guide path 84. The pressing force presses the spring slider 88 against the slide surface 84a of the sliding guide path 84 to generate the frictional resistance between the sliding plate part 88b of the spring slider 88 that slides along the sliding guide path 84 and the slide surface 84a of the sliding guide path 84. The frictional resistance is generated in a direction opposite the sliding direction of the slider 88 when the accelerator pedal 74 is rotated. Consequently, when the accelerator pedal 74 is depressed, the frictional resistance is applied in the same direction as the return force that is applied to the spring slider 88, so that the pedal force, which corresponds to the resultant of the return force and the frictional resistance, is necessary for the operation of the accelerator pedal 74. On the other hand, when the accelerator pedal 74 is returned, the frictional resistance is applied in an opposite direction of the return force applied to the spring slider 88, so that the pedal force that corresponds to the remainder of subtraction of the frictional resistance from the return force is necessary for the operation of the accelerator pedal 74. Thus, even if the amount of the depression (rotation angle) of the accelerator pedal 74 is the same, the pedal force that is necessary for the operation differs between when the accelerator pedal 74 is depressed and returned, so that the hysteretic properties can be obtained. The hysteretic properties facilitate the operation of the accelerator pedal 74.

When the slide surface 84a of the sliding guide path 84 or the sliding plate part 88b of the spring slider 88 wears, the spring slider 88 moves along the convex sloped engaging surfaces 86d, 86e of the moving member 86 to approach the moving member 86 in the sliding direction of the spring slider 88 because of the spring 90. Accordingly, the spring slider 88 moves toward the slide surface 84a of the sliding guide path 84 on a side of the sliding plate part 88b. As a result, even if the thickness of the slide surface 84a of the sliding guide path 84 or the spring slider 88 decreases due to the wearing, the slide surface 84a of the sliding guide path 84 and the sliding plate part 88b of the spring slider 88 remain in contact. When the spring slider 88 slides along the sliding guide path 84, it is ensured that the frictional resistance is constantly generated between the slide surface 84a and the sliding plate part 88b. In this manner, the spring slider 88 absorbs the decrease in the thickness of the slide surface 84a of the sliding guide path 84 or the spring slider 88 (especially sliding plate part 88b) by sliding in a direction in which the spring 90 stretches. Consequently, the amount of compression of the spring 90 when the accelerator pedal 74 is in its initial position decreases as compared to that before the wearing, and the return force applied to the spring slider 88 by the spring 90 decreases as compared to that before the wearing of the slide surface 84a or the spring slider 88 (especially sliding plate part 88b).

In the accelerator pedal apparatus 70 of the third embodiment, the convex sloped engaging surfaces 86d, 86e of the moving member 86 and the convex sloped engaging surfaces 88e, 88d of the spring slider 88 have convexly curved shapes on the cross-sectional surface that is perpendicular to the rotational axis line O. Due to the wearing of the slide surface 84a of the sliding guide path 84 or the spring slider 88 (especially sliding plate part 88b), the sliding plate part 86b of the moving member 86 and the sliding plate part 88b of the spring slider 88 are separated in a direction of application of the pressing force. Accordingly, angles, which tangent planes at engaging parts of the convex sloped engaging surfaces 86d, 86e of the moving member 86 and the convex sloped engaging surfaces 88e, 88d of the spring slider 88 make with a plane (i.e., slide surface 84a) that is perpendicular to the direction of the application of the pressing force, decrease. Therefore, a ratio, in which force applied to the moving member 86 through the pedal force that is applied to the accelerator pedal 74 is converted into the pressing force, increases, thereby increasing the frictional resistance between the sliding plate part 88b of the spring slider 88 and the slide surface 84a of the sliding guide path 84. Therefore, in the accelerator pedal apparatus 70 of the present embodiment as well, when the accelerator pedal 74 is depressed, the decrease in the return force is compensated with the increase in the frictional resistance, thereby decreasing an effect that the decrease in the return force has upon a feeling of the operation of the accelerator pedal 74. More specifically, by setting curvatures of the convex sloped engaging surfaces 86d, 86e, 88d, 88e, such that when the accelerator pedal 74 is depressed, the pedal force that is necessary for operating the accelerator pedal 74 at a predetermined rotation angle is the same before and after the return force decreases, the pedal force that is necessary for depressing the accelerator pedal 74 does not differ before and after the return force decreases. Hence, the effect that the decrease in the return force has upon the feeling of the operation becomes marginal.

Thus far, the accelerator pedal apparatus of the present invention has been described based on the embodiments shown in the drawings. Nevertheless, the present invention is not limited to those embodiments shown in the drawings. For example, the pedal apparatus can be employed for any pedal system other than an accelerator for controlling an internal combustion engine. Furthermore, in the accelerator pedal apparatuses according to first to third embodiments, the decrease in the return force is compensated by increasing the frictional resistance, which is generated by rotating the accelerator pedal, and the sloped engaging surface having a convexly curved shape at the engaging part between the pedal force transmission member and the pressuring member is only illustrative of a means for increasing the frictional resistance when the return force decreases. Thus, as long as the frictional resistance can be increased when the return force decreases, other means may be employed instead of the convexly sloped engaging surface.

While only the selected example embodiments have been chosen to illustrate the present disclosure, it will be apparent from this disclosure that various changes and modifications can be made therein without departing from the scope of the disclosure as defined in the appended claims. Furthermore, the foregoing description of the example embodiments according to the present disclosure is provided for illustration only, and not for the purpose of limiting the disclosure as defined by the appended claims and their equivalents.

What is claimed is:

1. A pedal apparatus comprising:
a pedal for depression by an operator from an initial position;
a pressuring member for increasing return force when an amount of depression of the pedal increases, wherein the return force returns the pedal to the initial position; and
a frictional member that generates a frictional resistance, wherein:
when the pedal is depressed, the frictional resistance is applied to the pedal in the same direction as the return force;
when the pedal is returned towards the initial position, the frictional resistance is applied to the pedal in an opposite direction of the return force; and
when the return force, which is applied to the pedal according to a predetermined amount of the depression of the pedal, decreases, the decrease in the return force in depressing the pedal is compensated by increasing the frictional resistance.

2. The pedal apparatus according to claim 1, further comprising a pedal force transmission member that is synchronized with the pedal, wherein pedal force that is applied to the pedal is transmitted to the pedal force transmission member, wherein:
the pressuring member engages with the pedal force transmission member;
the pressuring member applies the return force for returning the pedal to the initial position to the pedal via the pedal force transmission member;
the frictional member contacts the pressuring member and the frictional resistance is generated between the pressuring member and the frictional member; and
when the return force, which is applied to the pedal according to the predetermined amount of the depression of the pedal, decreases, the frictional resistance between the pressuring member and the frictional member is increased by increasing a force that presses the pressuring member against the frictional member.

3. The pedal apparatus according to claim 2, further comprising a force conversion mechanism that includes a first convexly sloped engaging surface, which is formed on a first surface of the pedal force transmission member, and a second convexly sloped engaging surface, which is formed on a second surface of the pressuring member, wherein:
the first and second convexly sloped engaging surfaces engage with each other at an engaging part;
the pedal force, which is applied to the pressuring member via the pedal force transmission member by the pedal through an engaging part between the first convexly sloped engaging surface and the second convexly sloped engaging surface, is converted into a force that resists the return force and the force that presses the pressuring member against the frictional member, wherein the force that resists the return force is applied to the pressuring member; and
an angle, which a tangential plane at the engaging part makes with a plane perpendicular to a direction of the force that presses the pressuring member against the frictional member, decreases as the pedal force transmission member and the pressuring member move away from each other in the direction of the force that presses the pressuring member against the frictional member.

4. The pedal apparatus according to claim 3, further comprising a housing that rotatably supports the pedal, wherein:
the pedal is formed integrally with the pedal force transmission member;
the pressuring member, which is a spring rotor, rotates around a rotational axis line of the pedal in synchronization with the pedal, and applies the return force for returning the pedal to the initial position to the pedal;
the frictional member is a friction plate and is disposed between the spring rotor and the housing, and is fixed against rotation relative to the housing;
the first and second convexly sloped engaging surfaces are formed on the pedal force transmission member and the spring rotor, respectively, in a predetermined cylindrical surface, which is set around the rotational axis line, and are opposed to each other in a direction of an axis line of the predetermined cylindrical surface, wherein the end faces of the pedal force transmission member and the spring rotor are opposed to each other in a direction of the rotational axis line; and
the first and second convexly sloped engaging surfaces have convexly curved shapes on a cut plane that is along the predetermined cylindrical surface to increase the force that presses the spring rotor against the friction plate when the return force decreases.

5. The pedal apparatus according to claim 4, wherein curvatures of the first and second convexly sloped engaging surfaces are such that the pedal force, which is necessary for a constant amount of the depression of the pedal, is approximately the same before and after a thickness of the friction plate or the spring rotor decreases when the pedal is depressed.

6. The pedal apparatus according to claim 3, further comprising a housing that rotatably supports the pedal, wherein:
the pedal is formed integrally with the pedal force transmission member;
the pressuring member which is a spring slider, engages with the pedal force transmission member, rotates around a rotational axis line of the pedal in synchronization with the pedal, and applies the return force for returning the pedal to the initial position to the pedal;
the frictional member includes an inner surface of the housing, wherein the inner surface contacts the spring slider;
the first and second convexly sloped engaging surfaces are formed on respective surfaces the pedal force transmission member and the spring slider between the rotational axis line and the inner surface, and are opposed to each other in a rotational direction of the pedal force transmission member and the spring slider, wherein the surfaces of the pedal force transmission member and the spring slider are opposed to each other in the rotational direction of the pedal force transmission member and the spring slider; and
the first and second convexly sloped engaging surfaces have convexly curved shapes on a cross-sectional surface that is perpendicular to the rotational axis line to increase the force that presses the spring slider against the inner surface when the return force decreases.

7. The pedal apparatus according to claim 6, wherein curvatures of the first and second convexly sloped engaging surfaces are determined such that the pedal force, which is necessary for a constant amount of the depression of the pedal, is approximately the same before and after a thickness of the inner surface or the spring slider decreases when the pedal is depressed.

8. The pedal apparatus according to claim 3, further comprising a housing that supports the pedal rotatably around a rotational axis line, wherein:
the frictional member is formed as an inner surface of a sliding guide path that extends parallel to a perpendicular of the rotational axis line in the housing;
the pedal force transmission member, which is a moving member, is movably provided in the sliding guide path, and engages with and detaches from one end of the pedal;
the pressuring member, which is a spring slider, is movably provided in the sliding guide path in opposition to the moving member, and applies the return force for returning the pedal to its initial position to the pedal via the moving member;
the first and second convexly sloped engaging surfaces are formed on surfaces of the moving member and the spring slider, respectively, and are opposed to each other in a moving direction of the moving member and the spring slider, wherein the surfaces of the moving member and the spring slider are opposed to each other in the moving direction of the moving member and the spring slider in the sliding guide path; and
the first and second convexly sloped engaging surfaces have convexly curved shapes on a cross-sectional surface that is perpendicular to the rotational axis line to increase the force that presses the spring slider against the inner circumferential surface when the return force decreases.

9. The pedal apparatus according to claim 8, wherein curvatures of the first and second convexly sloped engaging surfaces are determined such that the pedal force, which is necessary for a constant amount of the depression of the pedal, is approximately the same before and after a width of the sliding guide path increases, or before and after a thickness of the spring slider decreases, when the pedal is depressed.

10. The pedal apparatus according to claim 1, wherein the pedal is an accelerator pedal for controlling acceleration of a vehicle.
